(19) United States
(12) Patent Application Publication
(10) Pub. No.: US 2023/0368254 A1
(43) Pub. Date: Nov. 16, 2023

(54) INFORMATION TERMINAL FOR RETAIL SALES TRANSACTIONS AND METHOD FOR INFORMATION TERMINAL FOR RETAIL SALES TRANSACTIONS

(71) Applicant: Toshiba Tec Kabushiki Kaisha, Tokyo (JP)

(72) Inventor: Nobutomo NODERA, Izu Shizuoka (JP)

(21) Appl. No.: 18/165,784

(22) Filed: Feb. 7, 2023

(30) Foreign Application Priority Data
May 16, 2022 (JP) 2022-080157

(51) Int. Cl. G06Q 30/0282; G06Q 30/0601

(52) U.S. Cl. CPC G06Q 30/0282; G06Q 30/0631

(57) ABSTRACT

An information terminal in an embodiment can be operated by a customer on a store floor to register commodities for purchase. The terminal includes a commodity code reader to read commodity codes on commodities to be purchased and a display screen to display information to the customer and receive input operations. A communication interface to communicate with a server device is provided along with a processor. The processor acquires a commodity code for an item to be purchased from the commodity code reader or otherwise, sends a registration request including the acquired commodity code to the server device via the communication interface to request the server device to perform sales registration on the corresponding item, and displays evaluation information associated with the commodity code in the server device on the display screen when the server device sends the evaluation information in response to the request.

### CROSS-REFERENCE TO RELATED APPLICATION

This application is based upon and claims the benefit of priority from Japanese Patent Application No. 2022-080157, filed May 16, 2022, the entire contents of which are incorporated herein by reference.

### FIELD

Embodiments described herein relate generally to an information terminal for registering items in retail sales transactions and a method executed by such an information terminal for the promotion of retail sales transactions.

### BACKGROUND

A retail store usually sells a several different types of items. Some of items of the same type but from manufacturers may also be sold. A customer selects an item to be purchased from the different items displayed on a sales floor or the like. Therefore, it may be advantageous that an item can be selected at the store by reference to the evaluations the available items by others at the store.

A self commodity registration system using an information terminal, such as the customer's smartphone or a tablet terminal, as a commodity registration terminal has been put into practical use in supermarkets and the like. Therefore, when a purchaser who uses such an information terminal to make purchases of items on the sales floor, if there is a mechanism by which an evaluation of an item that has been performed by another person can be confirmed, advantages of the self commodity registration system may be considered further improved.

### BRIEF DESCRIPTION OF THE DRAWINGS

FIG. 1 is a block diagram illustrating a schematic configuration of a self commodity registration system according to an embodiment.

FIG. 2 is a schematic diagram illustrating a configuration of member data stored in a member data file.

FIG. 3 is a schematic diagram illustrating a configuration of commodity data stored in a commodity data file.

FIG. 4 is a schematic diagram illustrating a configuration of evaluation data stored in an evaluation data file.

FIG. 5 is a block diagram illustrating a configuration of a registration support server.

FIG. 6 is a schematic diagram illustrating data stored in a transaction file.

FIG. 7 is a block diagram illustrating a configuration of an information terminal.

FIG. 8 and FIG. 9 are flowcharts of information processing executed by a processor of an information terminal according to a self registration program.

FIG. 10 and FIG. 11 are flowcharts of evaluation confirmation processing.

FIG. 12 is a flowchart of information processing executed by a processor of an information terminal according to a self registration program.

FIG. 13 is a flowchart of check-in request processing executed by a processor of a registration support server.

FIG. 14 is a flowchart of registration request processing.

FIG. 15 is a flowchart of evaluation request processing.

FIG. 16 is a flowchart of comparison request processing.

FIG. 17 is a flowchart of cancel request processing.

FIG. 18 is a flowchart of settlement request processing.

FIG. 19 is a flowchart of evaluation waiting request processing.

FIG. 20 is a flowchart of evaluation notification processing.

FIG. 21 is a schematic diagram illustrating an example of a second top screen displayed on a touch panel.

FIG. 22 is a schematic diagram illustrating an example of a registration screen.

FIG. 23 is a schematic diagram illustrating an example of an evaluation screen.

FIG. 24 is a schematic diagram illustrating an example of a comparison screen.

FIG. 25 is a schematic diagram illustrating an example of a checkout screen.

FIG. 26 is a schematic diagram illustrating an example of an evaluation input screen.

FIG. 27 is a schematic diagram illustrating another embodiment of evaluation data.

FIG. 28 is a schematic diagram illustrating another embodiment of an evaluation screen.

FIG. 29 is a schematic diagram illustrating an example of an evaluator list screen displayed on a touch panel of an information terminal according to an embodiment.

### DETAILED DESCRIPTION

An object of embodiments described herein is to permit a customer using an information terminal in a self-service type commodity registration system while moving about a store sales floor to the like to more easily check and review a product evaluation or the like provided by another person regarding a commodity available for purchase on the sales floor. That is, certain embodiments represent improvements over existing self-service type commodity registration systems (and information terminals thereof) with respect to customer convenience of use and sales promotion.

In one embodiment, an information terminal that can be operated by a purchaser on a store sales floor to register commodities for purchase in conjunction a server device for supporting registration of commodities to be purchased includes a commodity code reader configured to read commodity codes on commodities to be purchased, a display screen configured to display information to a purchaser and receive input operations from the purchasers, a communication interface configured to communicate with the server device, and a processor. The processor is configured to: acquire a commodity code for an item to be purchased from the commodity code reader or an input operation via the display screen; send a registration request including the acquired commodity code to the server device via the communication interface to request the server device to perform sales registration on the corresponding item; and display evaluation information associated with the commodity code in the server device on the display screen when the server device sends the evaluation information in response to the registration request. The evaluation information includes an evaluation (e.g., a product review or rating) of the item by another person.

Hereinafter, certain example embodiments will be described with reference to the drawings.

A described example embodiment is applied to a self commodity registration system in which an information terminal, such as a smartphone or a tablet terminal, is used as a commodity registration terminal by a purchaser. The purchaser uses the information terminal to make purchases of at least one commodity on a sales floor of a store. The example embodiment permits an evaluation of the commodity provided (made) by another person to be easily viewed and checked. The evaluation information provided by another person in this context regarding a commodity (a “to-be-purchased commodity”) is such things a product rating, a purchase satisfaction score, a product value rating, consumer rating score, or other information related to an evaluation of a commodity performed by another purchaser of the commodity (or a substantially similar commodity).

### Description of Configuration of Self Commodity Registration System

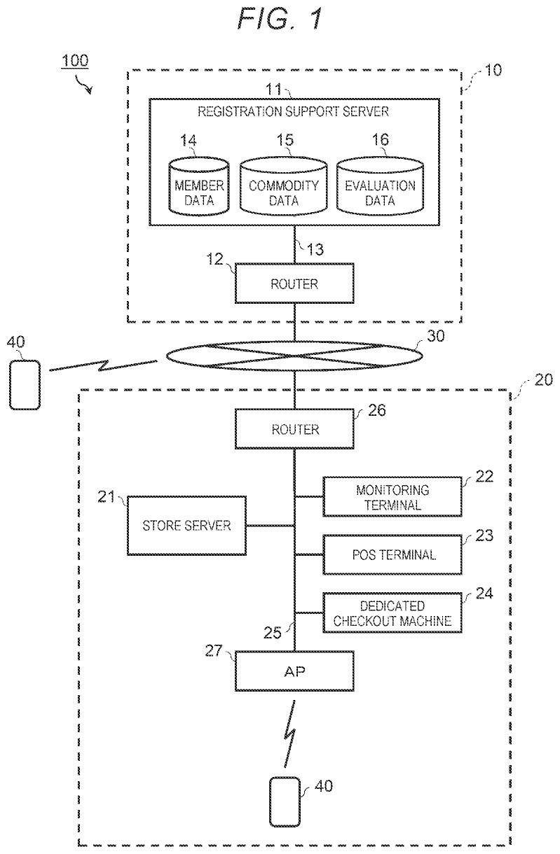

FIG. 1 is a block diagram illustrating a schematic configuration of a self commodity registration system 100 according to an embodiment. The self commodity registration system 100 includes a server system 10 (using cloud computing) and a point of sales (POS) system 20 constructed in a store. The store is a retail store such as a supermarket with a sales floor on which commodities are displayed and a checkout place (cash register area) for performing checkout processes are separated from each other. More than one such store may be a part of the self commodity registration system 100. The POS system 20 of a plurality of stores such as a chain store and a shared server system 10 may constitute the self commodity registration system 100 in some examples.

The server system 10 and the POS system 20 can perform bidirectional data communication through a network 30 using an Internet protocol. The network 30 is a wide area network in which a public line or a dedicated line is used as a relay network and a wired local area network (LAN), a wireless LAN, a mobile communication network, a mobile phone communication network, or the like is used as an access network.

An information terminal 40 that may use the mobile phone communication network can access the server system 10 via the network 30. The information terminal 40 functions as a commodity registration terminal. For example, a smartphone owned by a customer, a dedicated mobile terminal provided by a store, or a tablet terminal attached to a shopping cart can be used as the information terminal 40. In the present embodiment, a smartphone will be described as an example of the information terminal 40.

The server system 10 includes a registration support server 11 and a router 12, which are connected to each other via a communication line 13. The router 12 is also connected to the network 30, and serves as a relay site of data communication using the network 30 between the registration support server 11 and the POS system 20.

The registration support server 11 is a computer for supporting a self registration operation of a to-be-purchased commodity for a customer (referred to in this context as a purchaser) who shops in a store by using the information terminal 40. For the support, the registration support server 11 has at least the following two functions. The first function is registering commodity sales data based on information related to the to-be-purchased commodity input using the information terminal 40. In this example, the registration support server 11 has a function of causing the information terminal 40 to output evaluation information when such evaluation information regarding the to-be-purchased commodity from another person is present/available. The second function is settling a transaction with the purchaser using the information terminal 40 in response to a checkout instruction from the information terminal 40.

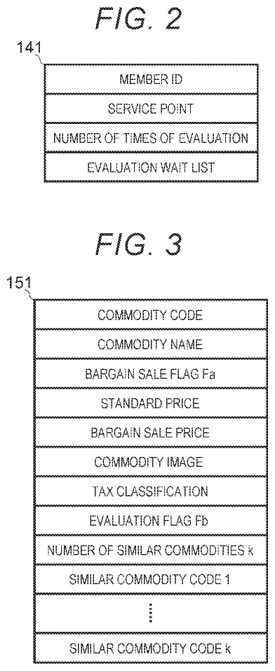

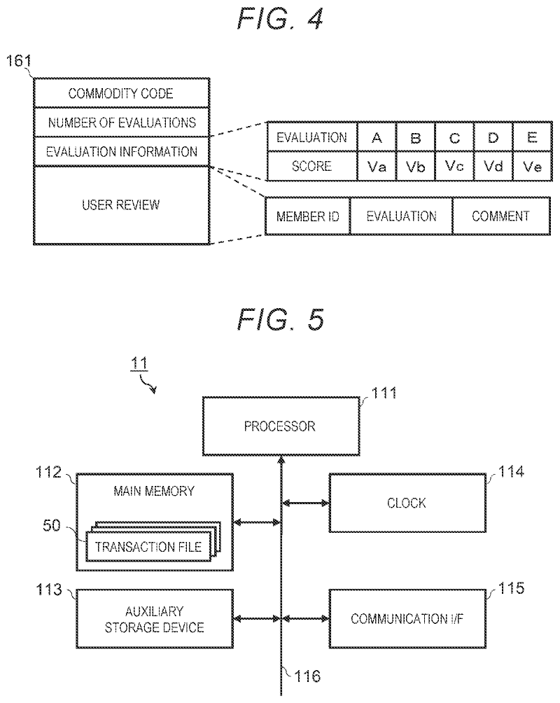

The registration support server 11 includes at least a member data file 14, a commodity data file 15, and an evaluation data file 16 in order to implement the first function. The member data file 14 is a collection of member data 141 (see FIG. 2) generated for each registered user of a shopping application service or the like. The member can be, for example, a registered member of a customer loyalty program (referred to as a “point member”). The commodity data file 15 is a collection of commodity data 151 (see FIG. 3) generated for individual commodities. In this context, the relevant commodity is a commodity sold in the store. The evaluation data file 16 is a collection of evaluation data 161 (see FIG. 4) generated for certain evaluation target commodities for which an evaluation of a significance, a value, or the like has been requested by the purchaser. Which commodities are set as an evaluation target commodity can be determined by, for example, each store. In some examples, the manufacturer of the commodity may determine the evaluation target commodities.

FIG. 2 is a schematic diagram illustrating a configuration of the member data 141. As illustrated in the drawing, the member data 141 includes items of a member ID, a service point (point total), the number of previous evaluations, and an evaluation waiting list. The member ID is a unique code set for each member in order to individually identify each member. The member installs application software dedicated to the specific member in the information terminal 40 owned by the member or the like. By this installation, a member ID unique to the information terminal 40 is set. When such a member shops at the store using the information terminal 40, the member is referred to as a purchaser.

The service point is a total number of points given to the member for previous actions or a points balance. The member can use the accumulated service points for payment or the like of a commodity (or commodities) at the store. The number of times of evaluation is the number of times the member has provided evaluations of a to-be-purchased commodity or the like. In some examples, the evaluation of a commodity can be performed online from the information terminal 40 or other access method. The evaluation waiting list includes one or more pieces of evaluation waiting data. In this context, the evaluation waiting data includes a commodity code and a commodity name of a commodity which has not yet been evaluated by the member among the evaluation target commodities that have been previously purchased by the member.

FIG. 3 is a schematic diagram illustrating a configuration of the commodity data 151. As illustrated, the commodity data 151 includes a commodity code, a commodity name, a bargain sale flag Fa, a standard price, a bargain sale price, a commodity image, a tax classification, an evaluation flag Fb, the number of similar commodities k, and the similar commodity codes up to the number k. The commodity code is a unique code set for each commodity for identifying each commodity. Barcodes representing the commodity codes are attached to commodities. However, there may also be some items (commodity types) such as fresh food to which a barcode is not attached. The commodity name, the bargain sale flag Fa, the standard price, the bargain sale price, the commodity image, the tax classification, the evaluation flag Fb, the number of similar commodities k, and the corresponding similar commodity code (1 to k) can be set for each commodity specified by a corresponding commodity code.

The bargain sale flag Fa is 1-bit data for identifying whether the commodity is sold at a normal price or at a bargain sale price. In the present embodiment, the bargain sale flag Fa of the commodity sold at the normal price is set to “0”, and the bargain sale flag Fa of the commodity sold at the bargain sale price is set to “1”.

The evaluation flag Fb is 1-bit data for identifying whether the commodity is an evaluation target commodity. In the present embodiment, the evaluation flag Fb of the evaluation target commodity is set to “1”, and an evaluation flag Fb of a non-evaluation target commodity is set to “0”.

The number of similar commodities k is the number of other commodities considered to be significantly similar to the commodity, for example, similar commodities of the same category or type but made by different manufacturers (e.g., different brands of the same product) may be set as similar commodities. In other examples, items in the same basic product category but available in different flavors or styles and made by the same manufacturer, such as salad dressings, may be set as similar commodities. The similar commodity codes (1 to k) is a commodity code for a commodity set as a similar commodity. Similar commodities do not necessarily exist for all the commodities sold at the store. For the commodity data 151 of a commodity for which the similar commodity does not exist, the number of similar commodities k can be set to “0” and a similar commodity code is not included in the commodity data 151 for such a product.

FIG. 4 is a schematic diagram illustrating a configuration of the evaluation data 161. As illustrated in the drawing, the evaluation data 161 includes a commodity code, the number of evaluations, evaluation information, and a user review. The commodity code is a commodity code of the evaluation target commodity. The number of evaluations, the evaluation information, and the user review are information related to evaluations performed by a purchaser of the evaluation target commodity. The number of evaluations is the number of evaluations performed by a purchaser.

The evaluation information includes scores (e.g., score Va, score Vb, score Vc, score Vd, and score Ve) from previous evaluators (purchasers) for each evaluation level (evaluation A, evaluation B, evaluation C, evaluation D, and evaluation E) of the evaluation target commodity. In this example, the evaluation scores are set on a 5-point scale with the evaluation A, the evaluation B, the evaluation C, the evaluation D, and the evaluation E being in descending order on this 5-point scale. The values in the score row are the number of evaluations received for the commodity at the corresponding scale column value. For example, when a purchaser gives the evaluation target commodity a level of evaluation A, value in the score Va entry in the evaluation data 161 for the commodity is increased by one point.

In this context, the “user review” entry is any comment from the purchaser regarding the commodity. A comment that relates to an evaluation, such as “I think it goes well with tomato salad” or “I felt that the quantity is a little small”, is added to the evaluation data 161 as a user review. The user reviews are posted by a purchaser who has purchased the commodity. A purchaser who can post such a user review is a member who used the information terminal 40 for purchasing the commodity. The member ID of the purchaser who posts the user review and the evaluation score (evaluation A, evaluation B, evaluation C, evaluation D, or evaluation E) from the purchaser are associated with the comment of the user review. In some examples, the gender, the age, or the like of the purchaser may be associated with the comment. In addition, a posting date may be added, and a user review after a certain period from the posting date may be automatically deleted or excluded from the evaluation data 161. Accordingly, the required data capacity of the evaluation data file 16 can be kept stable.

The description returns to FIG. 1.

The POS system 20 includes a store server 21, a monitoring terminal 22, a POS terminal 23, a dedicated checkout machine 24, or the like, and these units are connected by an in-store network 25. In addition, in the POS system 20, a router 26 is connected to the in-store network 25, and the POS system 20 is connected to the network 30 via the router 26. In the POS system 20, an access point 27 is connected to the in-store network 25 and this enables data communication with the information terminal 40 through the wireless LAN via the access point 27.

The store server 21 is a computer for managing (tracking) sales information of the store, inventory information of a commodity, order information, or the like based on information regarding transactions settled in the store in which the POS system 20 is installed.

The monitoring terminal 22 is a terminal for monitoring a purchaser who is performing a self registration operation on a to-be-purchased commodity by using the information terminal 40. The monitoring terminal 22 includes a monitor (e.g., a display screen), and an indication of a present behavior of the purchaser in the store, the data related to the to-be-purchased commodities of the purchaser, or the like are presented on the monitor.

The POS terminal 23 can be a checkout machine that processes settlement of a transaction with a purchaser who does not use the information terminal 40 for shopping. An operator of the POS terminal 23 can be a store clerk. In some examples, the POS terminal 23 may be separated into a registration machine (commodity registration device) and a checkout machine (settlement terminal or payment kiosk). Such a registration machine may be operated by the store clerk, and the corresponding checkout machine may be operated by a purchaser in what is referred to as a semi-self-service-type system. In some examples, the POS terminal 23 may be a full-self-service-type system that is entirely operated by a purchaser.

The dedicated checkout machine 24 in this example is a checkout machine that processes settlement of a transaction with a purchaser who uses the information terminal 40. At the dedicated checkout machine 24, the purchaser is the operator. The dedicated checkout machine 24 has a function of scanning a checkout barcode displayed on the information terminal 40, a payment processing function corresponding to various possible payment methods such as electronic money, a credit card, and cash, and an electronic money charging function (that is, adding money to an electronic money account).

### Description of Configuration of Registration Support Server

FIG. 5 is a block diagram illustrating a configuration of the registration support server 11. The registration support server 11 includes a processor 111, a main memory 112, an auxiliary storage device 113, a clock 114, a communication interface 115, and a system transmission path 116. The system transmission path 116 includes an address bus, a data bus, a control signal line, or the like.

The processor 111 controls each unit to implement various functions as the registration support server 11 according to an operating system and/or an application program (application software). The processor 111 is, for example, a central processing unit (CPU).

The main memory 112 includes a nonvolatile memory area and a volatile memory area. The main memory 112 stores, in the nonvolatile memory area, an operating system or an application program. The main memory 112 stores, in the volatile memory area, data necessary for the processor 111 to execute processing for controlling each unit. The data may be stored in the nonvolatile memory area. The main memory 112 uses the volatile memory area as a work area in which data is appropriately rewritten by the processor 111. The nonvolatile memory area is, for example, a read only memory (ROM). The volatile memory area is, for example, a random access memory (RAM).

For example, an electric erasable programmable read-only memory (EEPROM), a hard disc drive (HDD), or a solid-state drive (SSD) may serve as the auxiliary storage device 113. The auxiliary storage device 113 stores data used when the processor 111 performs various types of processing, data generated by the processing of the processor 111, or the like. The auxiliary storage device 113 may store an application program.

The clock 114 measures a date and time. The registration support server 11 acquires the date and time measured by the clock 114 as the current date and time.

The communication interface 115 is a circuit for transmitting and receiving data to and from each device connected via the network 30 according to a predetermined communication protocol.

The registration support server 11 uses a part of the volatile area in the main memory 112 as a storage area for a plurality of transaction files 50. The transaction file 50 is generated for each purchaser who shops using the information terminal 40. In the transaction file 50, various pieces of data related to a commodity sales transaction with a purchaser is stored.

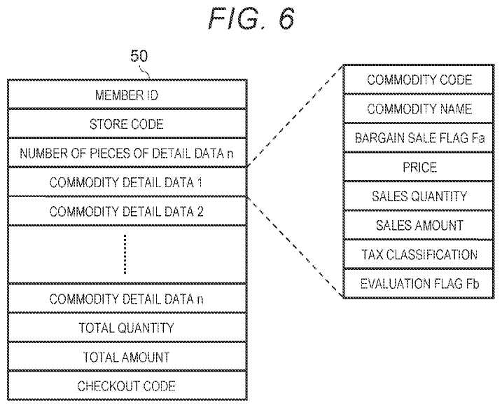

FIG. 6 is a schematic diagram illustrating data stored in the transaction file 50. As illustrated, the transaction file 50 stores a member ID, a store code, the number of pieces of detail data n, commodity detail data of the number n, a total quantity, a total amount, a checkout code, or the like. In the transaction file 50, the member ID functions as a transaction identification code for identifying a transaction with a purchaser. The transaction identification code may not be the member ID. The transaction identification code may be a code for identifying the information terminal 40. For example, a device ID or a mobile phone number of the information terminal 40 may be the transaction identification code. The transaction identification code may be, for example, a transaction number for identifying a transaction, or may be, in addition to the transaction number, a combination of a store code and date and time information such as a store entry date and time.

The store code is a unique code set for each store in order to individually identify the stores. The commodity detail data is data including items such as a commodity code, a commodity name, a bargain sale flag Fa, a price, a sales quantity, a sales amount, a tax classification, and an evaluation flag Fb of a to-be-purchased commodity. The price is a bargain sale price for a bargain sale commodity for which the bargain sale flag Fa is “1”, and is a normal price for a non-bargain sale commodity for which the bargain sale flag Fa is “0”.

The total quantity is a quantity obtained by adding up sales quantities of the respective commodity detail data. The total amount is an amount obtained by adding up sales amounts of the respective commodity detail data. The sales amount is calculated by multiplying the price by the sales quantity. The checkout code is a code used by a purchaser who checks in to the store specified by the store code using the information terminal 40 during checkout of a transaction.

### Description of Configuration of Information Terminal

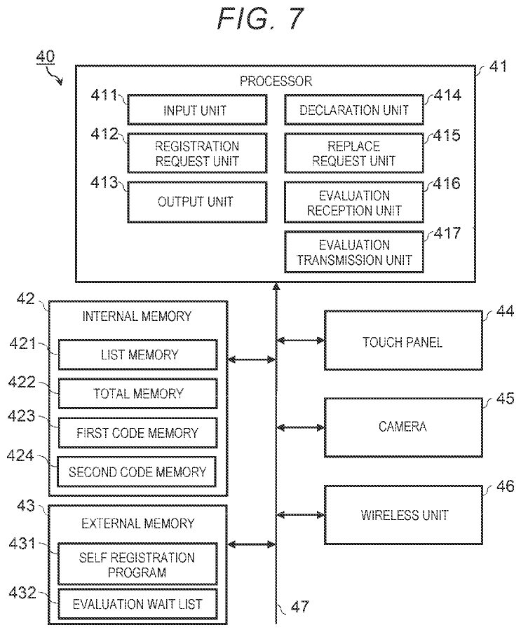

FIG. 7 is a block diagram illustrating a configuration of the information terminal 40. As illustrated in FIG. 7, the information terminal 40 includes a processor 41, an internal memory 42, an external memory 43, a touch panel 44, a camera 45, a wireless unit 46, and a system transmission path 47. The system transmission path 47 includes an address bus, a data bus, a control signal line, or the like.

The processor 41 controls each unit to implement various functions as the information terminal 40 according to an operating system or an application program (application software). The processor 41 is, for example, a CPU.

The internal memory 42 includes a nonvolatile memory area and a volatile memory area. The internal memory 42 stores the operating system and/or the application program in the nonvolatile memory area. The internal memory 42 stores, in the volatile memory area, data necessary for the processor 41 to execute processing for controlling each unit. In addition, the internal memory 42 uses the volatile memory area as a work area in which data is appropriately rewritten by the processor 41. The nonvolatile memory area is, for example, a ROM. The volatile memory area is, for example, a RAM.

The external memory 43 corresponds to an auxiliary storage unit of the computer. For example, an SD memory card or a USB memory may be the external memory 43. The external memory 43 stores data used when the processor 41 performs various types of processing, data generated by processing in the processor 41, or the like. The external memory 43 may store the above application program.

The touch panel 44 is a device in which a display as a display unit and a touch sensor as a detection unit are combined. The display has a screen for displaying various images. The touch sensor detects a position on the screen touched by the operator. The touch panel 44 acquires data input by the operator from a position on the screen detected by the touch sensor and information of an image displayed at the position.

The camera 45 is an imaging device built in to the information terminal 40. The camera 45 may be referred to as a commodity code reader. The processor 41 has a function as a reading unit that reads a code such as a bar code or a two-dimensional code from an image captured by the camera 45. Barcodes representing commodity codes of commodities in a predetermined barcode system are generally attached to the commodities at the store. That is, the processor 41 can acquire a commodity code of a to-be-purchased commodity by reading the barcode attached to the commodity from the image captured by the camera 45.

Accordingly, the touch panel 44 and the camera 45 function as input devices of the information terminal 40.

The wireless unit 46 is a communication device that performs data communication with the access point 27 according to a wireless LAN communication protocol.

In the information terminal 40 having such a configuration, a self registration program 431 is installed in the external memory 43. The self registration program 431 is application software for a commodity registration system executed by the information terminal 40. The self registration program 431 may be installed in the internal memory 42. A method of installing the self registration program 431 in the internal memory 42 or the external memory 43 is not particularly limited. The self registration program 431 can be recorded on a removable recording medium, or the self registration program 431 can be distributed by communication via a network, and the self registration program 431 can be installed in the internal memory 42 or the external memory 43. A form of the recording medium is not limited as long as the recording medium can store a program and can be read by a device, such as an SD memory card or a USB memory.

In the information terminal 40 in which the self registration program 431 is installed, a partial area of the external memory 43 is set as an area of an evaluation waiting list 432. In addition, a partial area of the internal memory 42 serves as a list memory 421, a total memory 422, a first code memory 423, and a second code memory 424. The list memory 421, the total memory 422, the first code memory 423, and the second code memory 424 may be formed in the external memory 43.

In the area of the evaluation waiting list 432, an evaluation waiting list included in the member data 141 of the member who is a user of the information terminal 40 is described. In the area of the list memory 421, a to-be-purchased commodity list of the transaction file 50 from the registration support server 11 is described. The to-be-purchased commodity list includes commodity detail data 1 to n corresponding to the number of pieces of detail data n. A total quantity and a total amount of the transaction file 50 are described in an area of the total memory 422. In the first code memory 423 and the second code memory 424, when a declaration to purchase a similar commodity instead of a previously to-be-purchased commodity is made, commodity codes of the similar commodity and the to-be-purchased commodity are described. Specifically, the commodity code of the similar commodity is described in the first code memory 423, and the commodity code of the to-be-purchased commodity is described in the second code memory 424.

In the information terminal 40 in which the self registration program 431 is installed, the processor 41 functions as an input unit 411, a registration request unit 412, an output unit 413, a declaration unit 414, a replace request unit 415, an evaluation reception unit 416, and an evaluation transmission unit 417. The input unit 411 has a function of inputting identification information of a to-be-purchased commodity via an input device such as the touch panel 44 or the camera 45. The identification information is typically a commodity code. A classification code for identifying a classification of a commodity may be the identification information. The registration request unit 412 has a function of requesting the registration support server 11 to perform sales registration of the to-be-purchased commodity identified by the identification information input by the input unit 411.

The output unit 413 has a function of outputting, when there is evaluation information by another person for the to-be-purchased commodity for which sales registration is requested by the registration request unit 412, the evaluation information. The evaluation information is displayed and output on a screen of the touch panel 44. The evaluation information includes evaluation information of a similar commodity similar to the to-be-purchased commodity. The output unit 413 outputs the evaluation information of the to-be-purchased commodity and the evaluation information of the similar commodity in a comparable manner.

The declaration unit 414 has a function of receiving a declaration to purchase the similar commodity instead of the previously to-be-purchased commodity. The declaration is received via the touch panel 44. In response to the declaration, the commodity code of the similar commodity is described in the first code memory 423, and the commodity code of the to-be-purchased commodity is described in the second code memory 424. The replace request unit 415 has a function of requesting the registration support server 11 to perform sales registration of the similar commodity instead of the to-be-purchased commodity, when the identification information input by the input unit 411 after the declaration is the identification information of the similar commodity, that is, when the identification information input by the input unit 411 matches with the commodity code described in the first code memory 423.

The evaluation reception unit 416 has a function of receiving evaluation information of the to-be-purchased commodity from the purchaser when the commodity whose sales registration is supported by the registration support server 11 is an evaluation target commodity. The evaluation information is received via the touch panel 44. The evaluation transmission unit 417 has a function of transmitting the evaluation information received by the evaluation reception unit 416 to the registration support server 11.

### Description of Operation of Self Commodity Registration System

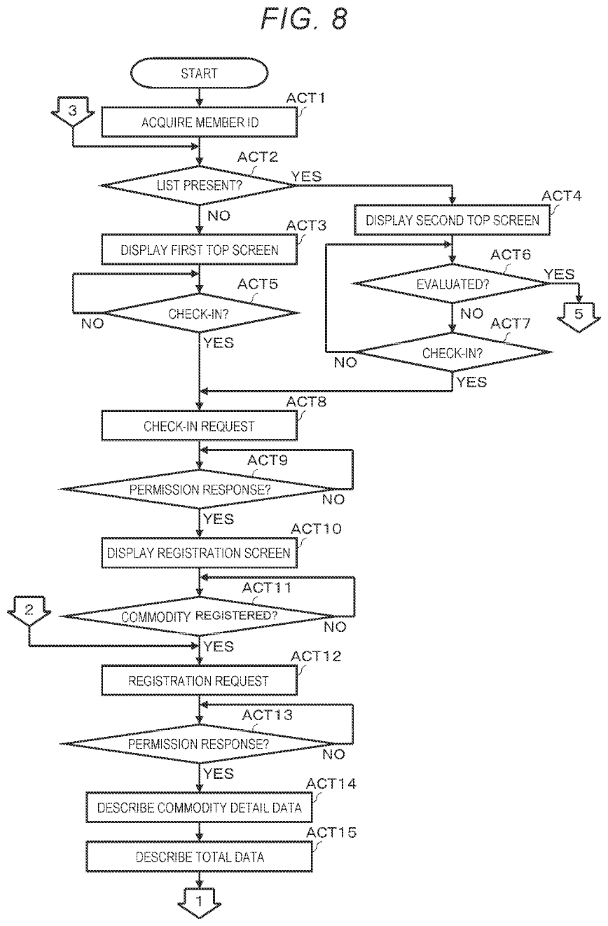

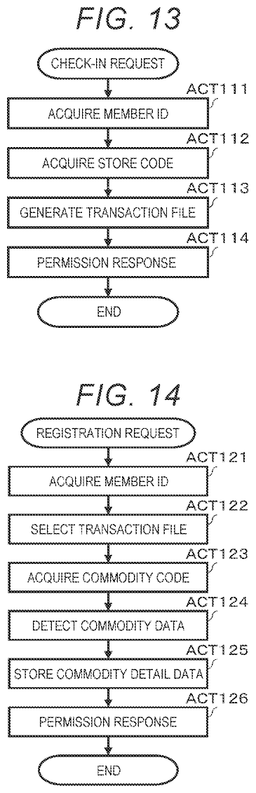

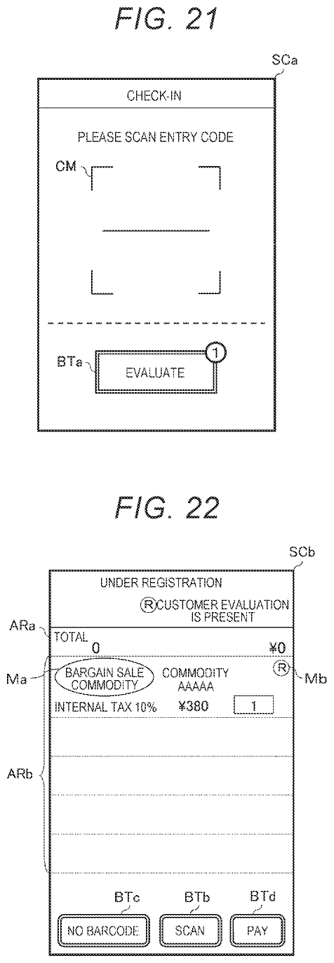

FIGS. 8 to 12 are flowcharts illustrating procedures of information processing executed by the processor 41 of the information terminal 40 according to the self registration program 431. FIGS. 13 to 20 are flowcharts illustrating procedures of information processing executed by the processor 111 of the registration support server 11 according to a program. FIGS. 21 to 26 are examples of screens displayed on the touch panel 44 of the information terminal 40. Hereinafter, certain operations of the self commodity registration system 100 will be described with reference to each drawing. The specific details of procedure and contents of the operations described below are only examples. As long as the same overall effect can be obtained, the procedure and/or the content of the operations can be appropriately changed. In addition, the depicted screens are non-limiting examples. The particular layouts, the images, the text, and the like on each depicted screen are non-limiting examples.

A customer (purchaser) who shops using the information terminal 40 in a store in which the self commodity registration system 100 is installed first activates the self registration program 431. Once the self registration program 431 is activated, the processor 41 of the information terminal 40 starts the information processing of the procedures illustrated in FIGS. 8 to 12. The processor 41 acquires a member ID set in the information terminal 40 as ACT 1 in FIG. 8. Next, the processor 41 checks whether the evaluation waiting list 432 is present in the external memory 43 as ACT 2. When the evaluation waiting list 432 is absent, the processor 41 determines NO in ACT 2 and proceeds to ACT 3. In ACT 3, the processor 41 sets the screen of the touch panel 44 as a first top screen. On the other hand, when the evaluation waiting list 432 is present, the processor 41 determines YES in ACT 2 and proceeds to ACT 4. In ACT 4, the processor 41 sets the screen of the touch panel 44 as a second top screen SCa (see FIG. 21).

FIG. 21 is a schematic diagram illustrating a display example of the second top screen SCa. As illustrated in the drawing, the second top screen SCa displays guidance for guiding a user to scan an entry code and a frame CM indicating a code reading area. In addition, on the second top screen SCa, an evaluation button BTa is disposed. The evaluation button BTa is operated when the member who is the user of the information terminal 40 evaluates the evaluation target commodity in the evaluation waiting list 432. On the evaluation button BTa, the number of pieces of evaluation waiting data stored in the evaluation waiting list 432 is represented by a circled number. On the other hand, the frame CM is also disposed on the first top screen. However, since the evaluation waiting list 432 is absent, the evaluation button BTa is not disposed. Alternatively, the evaluation button BTa is invalidated by gray-out.

The entry code is posted at an entrance of a store. The entry code encodes setting information related to the store using a two-dimensional code system. The setting information in this context includes a store code, in-store LAN data, mobile communication data, or the like. The in-store LAN data includes such things an SSID, a password, security information, or the like as necessary for the information terminal 40 to connect to the access point 27 using the wireless LAN. The mobile communication data may be such things a timeout time, the number of connection retries, or the like as necessary for the information terminal 40 to communicate with other devices of the self commodity registration system 100.

When the purchaser holds the camera 45 of the information terminal 40 over the posted entry code such that the entry code is contained in the frame CM of the first top screen SCa or the second top screen SCa, the entry code is read by the camera 45. Accordingly, an operation of holding the camera 45 of the information terminal 40 over the entry code is referred to as a check-in operation. The purchaser performs a check-in operation before starting shopping. The purchaser who checks in via the second top screen SCa can evaluate an evaluation waiting commodity by operating the evaluation button BTa.

The processor 41 displaying the first top screen in ACT 3 waits for a check-in operation to be performed in ACT 5. In addition, the processor 41 displaying the second top screen SCa in ACT 4 waits for input of the evaluation button BTa in ACT 6 or a check-in operation in ACT 7. When the check-in operation is performed in the wait state and the entry code is read by the camera 45, the processor 41 proceeds to ACT 8.

The processor 41 controls the wireless unit 46 to perform a check-in request in ACT 8. By this control, the wireless unit 46 connects to the access point 27 via the wireless LAN based on the in-store LAN data obtained from the entry code. After the wireless unit 46 is connected to the access point 27, the wireless unit 46 wirelessly transmits a check-in request command. The check-in request command is received by the access point 27 and transmitted to the registration support server 11 via the router 26 of the POS system 20. The check-in request command includes the member ID set in the information terminal 40. In addition, the store code obtained from the entry code is also included in the check-in request command. In the registration support server 11 that receives the check-in request command, check-in request processing is executed. The information terminal 40 may directly access the server system 10 via the network 30 without passing through the in-store LAN. In this case, the in-store LAN data is unnecessary.

FIG. 13 is a flowchart illustrating a procedure of the check-in request processing. When the processor 111 of the registration support server 11 receives the check-in request command via the communication interface 115, the processor 111 starts the check-in request processing. In ACT 111, the processor 111 acquires the member ID from the check-in request command. In addition, in ACT 112, the processor 111 acquires the store code from the check-in request command. In ACT 113, the processor 111 generates a new transaction file 50 in the main memory 112, and stores the member ID and the store code acquired from the check-in request command. Thereafter, in ACT 114, the processor 111 transmits a permission response command to the information terminal 40 which sent the check-in request command. As described above, the processor 111 ends the check-in request processing.

The description returns to FIG. 8.

In ACT 6, the processor 41 waits for the permission response command. When the permission response command is received via the wireless unit 46, the processor 41 proceeds to ACT 10. In ACT 10, the processor 41 switches a screen of the touch panel 44 from a top screen to a registration screen SCb (refer to FIG. 22).

FIG. 22 is a schematic diagram illustrating a display example of the registration screen SCb. As illustrated in the drawing, on the registration screen SCb, a scan button BTb, a no-barcode button BTc, and a payment button BTd are disposed. In addition, in the registration screen SCb, a part of the screen is set as a total display area ARa of a transaction, and the remaining part is set as a detail list display area ARb of a purchase commodity. The detail list display area ARb is divided into, for example, five detail areas, and is capable of displaying information related to a purchase commodity of up to five items, for example, a commodity name, a tax classification, a sales amount, or a sales quantity. When the number of items of the to-be-purchased commodity exceeds six, the commodity name or the like is not displayed in the detail list display area ARb in order from the to-be-purchased commodity having old registration. However, for example, by swiping the detail list display area ARb up and down, the information related to the to-be-purchased commodity having old registration is displayed on the detail list display area ARb. The sales amount is an amount calculated by multiplying the price by the sales quantity. The price is a bargain sale price when the to-be-purchased commodity is a bargain sale commodity, and is a normal price when the to-be-purchased commodity is a non-bargain sale commodity. In a detail area of the bargain sale commodity, a bargain sale commodity mark Ma indicating the bargain sale commodity is displayed. In addition, when there is evaluation information on the to-be-purchased commodity by another person, an evaluation mark Mb for notifying the purchaser of the fact is displayed in the detail area. By touching the detail area in which the evaluation mark Mb is displayed, the purchaser can check the evaluation information of another person.

The scan button BTb is an operator for instructing scanning of a barcode attached to a commodity. The no-barcode button BTc is an operator for instructing registration of a commodity to which a barcode is not attached. The payment button BTd is an operator for instructing payment for a transaction. Since shopping is not started at this time, the payment button BTd is not disposed. Alternatively, the payment button BTd is invalidated by gray-out.

The purchaser who confirms the registration screen SCb starts shopping. When the purchaser finds a to-be-purchased commodity on a sales floor, next the purchaser checks whether a barcode is attached to the to-be-purchased commodity. When the barcode is attached to the to-be-purchased commodity, the purchaser touches the scan button BTb. When the scan button BTb is touched, the screen of the touch panel 44 turns to a scan screen. The scan screen is a screen in which a frame indicating a barcode reading area is disposed. The purchaser holds the camera 45 of the information terminal 40 over the to-be-purchased commodity such that the barcode is inside the frame. Accordingly, the barcode is read by the function of the reading unit of the information terminal 40. Thus, a registration operation of the commodity to which the barcode is attached can be performed.

On the other hand, when a barcode is not attached to the to-be-purchased commodity, the purchaser touches the no-barcode button BTc. When the no-barcode button BTc is touched, the screen of the touch panel 44 turns to a list screen of commodities without a barcode. The purchaser performs an operation for selecting the commodity to be purchased from the list screen. Accordingly, the registration operation of the commodity to which the barcode is not attached can be performed.

In ACT 11, the processor 41 which controls the display of the registration screen SCb waits for the commodity code which is the identification information of the to-be-purchased commodity to be input by the function as the input unit 411. When the registration operation of the commodity described above is performed, the commodity code is input to the information terminal 40. When the commodity code is input, the processor 41 proceeds to ACT 12.

In ACT 12, the processor 41 controls the wireless unit 46 to perform a registration request by the function as the registration request unit 412. By this control, the wireless unit 46 wirelessly transmits a registration request command. The registration request command is received by the access point 27 and transmitted to the registration support server 11 via the router 26 of the POS system 20. The registration request command includes a commodity code that is identification information of a to-be-purchased commodity. In addition, the registration request command also includes a member ID. In the registration support server 11 that receives the registration request command, registration request processing is executed.

FIG. 14 is a flowchart illustrating a procedure of the registration request processing. Upon receiving the registration request command via the communication interface 115, the processor 111 of the registration support server 11 starts the registration request processing. In ACT 121, the processor 111 acquires a member ID from the registration request command. Then, in ACT 122, the processor 111 selects the transaction file 50 in which the member ID is stored. Hereinafter, the selected transaction file is referred to as a target transaction file 50.

In ACT 123, the processor 111 acquires the commodity code of the to-be-purchased commodity included in the registration request command. Then, in ACT 124, the processor 111 searches the commodity data file 15 and detects commodity data including the commodity code. In ACT 125, the processor 111 generates commodity detail data based on the commodity data and stores the commodity detail data in the target transaction file 50. At this time, the processor 111 adds “1” to the number of pieces of detail data n of the target transaction file 50 to recalculate the total quantity and the total amount.

After the processing of ACT 125 is completed, the processor 111 then transmits a permission response command to the information terminal 40 as ACT 126. The permission response command includes the commodity detail data corresponding to the number of pieces of detail data n stored in the target transaction file 50, the total quantity, and the total amount. As described above, the processor 111 ends the information processing after the registration request command is received.

The description returns to FIG. 8.

The processor 41 that sent the registration request command waits for the permission response command in ACT 13. When the permission response command is received via the wireless unit 46, the processor 41 proceeds to ACT 14. In ACT 14, the processor 41 describes, in the list memory 421, the commodity detail data corresponding to the number of pieces of detail data n included in the permission response command. In addition, in ACT 15, the processor 41 describes in the total memory 422 the total quantity and the total amount included in the permission response command.

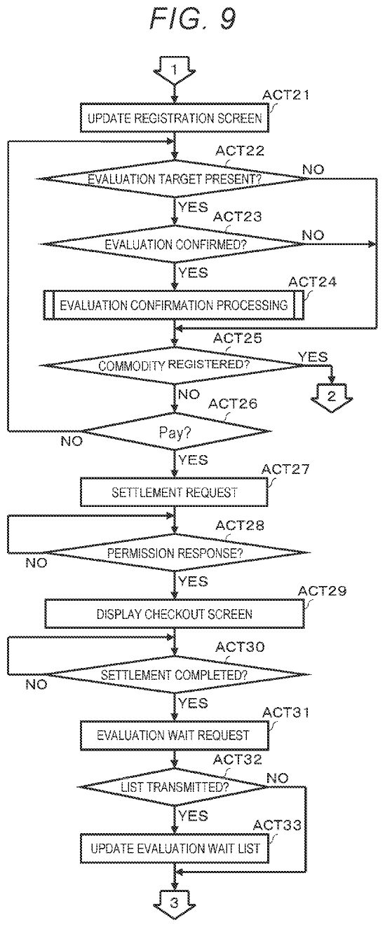

When the processing of ACT 14 and ACT 15 is completed, the processor 41 proceeds to ACT 21 of FIG. 9. In ACT 21, the processor 41 updates the registration screen SCb. Specifically, the processor 41 displays the total quantity and the total amount described in the total memory 422 on the total display area ARa. In addition, the processor 41 displays a commodity name, a tax classification, a sales amount, a sales quantity, or the like for each to-be-purchased commodity in each detail area of the detail list display area ARb based on the commodity detail data described in the list memory 421. At this time, when the to-be-purchased commodity is a bargain sale commodity, that is, when the bargain sale flag of the commodity detail data is “1”, the processor 41 displays the bargain sale commodity mark Ma in the detail area of the to-be-purchased commodity. In addition, when the to-be-purchased commodity is an evaluation target commodity, that is, when the evaluation flag Fb of the commodity detail data is “1”, the processor 41 displays the evaluation mark Mb in the detail area of the to-be-purchased commodity. In addition, since settlement is possible, the payment button BTd is enabled.

In ACT 22, the processor 41 then checks whether the evaluation target commodity is present in the purchased commodities. That is, when the commodity detail data in which the evaluation flag Fb is “1” is described in the list memory 421, the processor 41 recognizes that the evaluation target commodity is present. When the commodity detail data in which the evaluation flag Fb is “1” is not described in the list memory 421, the processor 41 recognizes that the evaluation target commodity is absent.

When the evaluation target commodity is absent, the processor 41 skips the processing of ACT 23 and ACT 24 and proceeds to ACT 25. In ACT 25, the processor 41 checks whether a registration operation on the commodity of the same type has already been performed. When the registration operation on the commodity has not been previously performed, the processor 41 next checks whether the payment button BTd is selected in ACT 26. When the payment button BTd is not selected, the processor 41 returns to ACT 22. As described above, when an evaluation target commodity is absent, the processor 41 waits for the registration operation on a commodity twice to be performed or the payment button BTd to be pressed.

On the other hand, when an evaluation target commodity is present, the processor 41 proceeds to ACT 23. In ACT 23, the processor 41 confirms whether an evaluation confirmation operation is performed. As described above, the evaluation confirmation operation is an operation of touching the detail area in which the evaluation mark Mb is displayed. If the evaluation confirmation operation is not performed (ACT 23; NO), the processor 41 proceeds to ACT 25. When the evaluation target commodity is present, the processor 41 waits for the evaluation confirmation operation to be performed, an operation of registering the commodity twice to be performed, or the payment button BTd to be input.

In the wait state of ACT 25 and ACT 26, or in the wait state of ACT 23, ACT 25, and ACT 26, when the registration operation of a commodity is performed twice, the processor 41 returns to ACT 12 of FIG. 8. Then, the processor 41 executes the processing after ACT 12 in the same manner as described above. If the to-be-purchased commodity having is not an evaluation target, the processor 41 enters the wait state of ACT 25 and ACT 26. When an evaluation target commodity is registered one or more times, the processor 41 enters the wait state of ACT 23, ACT 25, and ACT 26.

In the wait state of ACT 23, ACT 25, and ACT 26, after the evaluation confirmation operation is performed, the processor 41 proceeds to ACT 24. The processor 41 executes the evaluation confirmation processing in ACT 24.

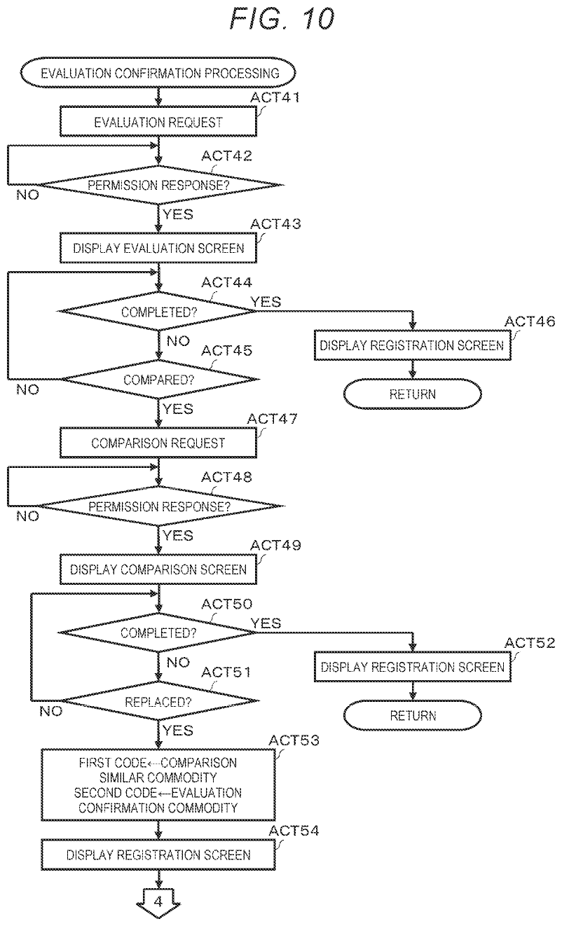

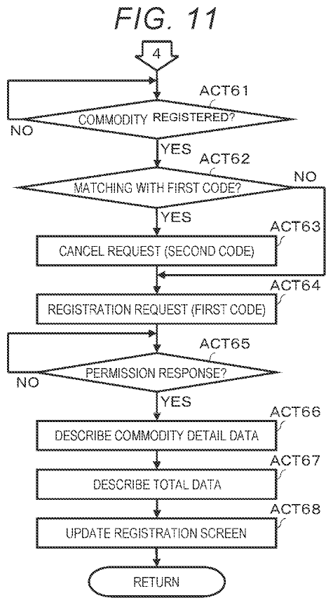

FIGS. 10 and 11 are flowcharts more specifically illustrating procedures of the evaluation confirmation processing. When the evaluation confirmation processing is started, the processor 41 controls the wireless unit 46 to perform an evaluation request in ACT 41 of FIG. 10. By this control, the wireless unit 46 wirelessly transmits an evaluation request command. The evaluation request command is received by the access point 27 and transmitted to the registration support server 11 via the router 26 of the POS system 20. The evaluation request command includes the commodity code (an evaluation commodity code) of the commodity displayed in the detail area for which the evaluation confirmation operation was performed. The evaluation request command also includes a member ID. The commodity identified by the evaluation commodity code is referred to as an evaluation confirmation commodity. In the registration support server 11 that receives the evaluation request command, the evaluation request processing is executed.

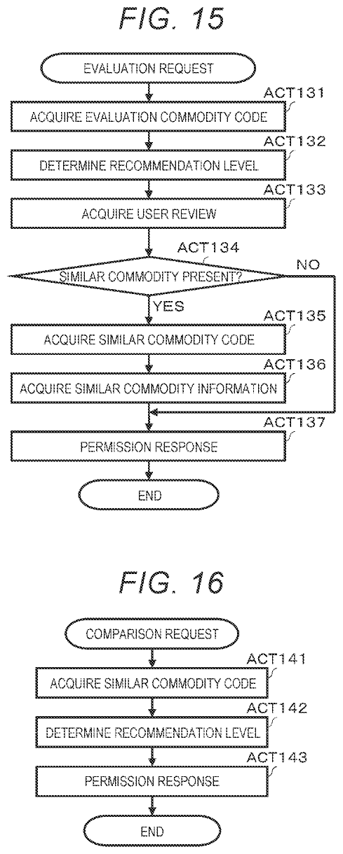

FIG. 15 is a flowchart illustrating a procedure of the evaluation request processing. Upon receiving the evaluation request command via the communication interface 115, the processor 111 of the registration support server 11 starts the evaluation request processing. In ACT 131, the processor 111 acquires the evaluation commodity code from the evaluation request command. Then, in ACT 132, the processor 111 determines a recommendation level of the evaluation confirmation commodity identified by the evaluation commodity code. That is, the processor 111 acquires the evaluation data 161 matching the evaluation commodity code from the evaluation data file 16. Then, the processor 111 sets the scale of the evaluation having the highest score in the evaluation information of the evaluation data 161 as the recommendation level. For example, the score Va, the score Vb, the score Vc, the score Vd, and the score Ve of the evaluation A, the evaluation B, the evaluation C, the evaluation D, and the evaluation E are compared, and when the score Va is a maximum value, the evaluation A is set as the recommendation level. Incidentally, when there are a plurality of scores of the maximum value, a higher evaluation is set as the recommendation level. Alternatively, a lower evaluation may be set as the recommendation level. A method of determining the recommendation level is not limited to the above method.

After the recommendation level of the evaluation confirmation commodity is determined, the processor 111 acquires a user review from the evaluation data 161 in ACT 133. Next, the processor 111 checks whether there is a similar commodity in ACT 134. That is, the processor 111 acquires the commodity data including the evaluation commodity code from the commodity data file 15. Then, the processor 111 acquires the number of similar commodities k of the commodity data. When the number of similar commodities k is “0”, the processor 111 determines that there is no similar commodity. When the number of similar commodities k is “1” or more, the processor 111 determines that there are similar commodities.

When there are similar commodities, the processor 111 proceeds to ACT 135. In ACT 135, the processor 111 acquires the commodity codes for the similar commodities (1 to k) from the commodity data matching the evaluation commodity code. In addition, in ACT 136, the processor 111 acquires all the commodity data matching the similar commodity codes from the commodity data file 15, and acquires the similar commodity information such as a commodity name, a price, and a commodity image from the commodity data for each similar commodity code. The price can be a bargain sale price when the similar commodity is a bargain sale commodity, that is, when the bargain sale flag Fa is “1”. When the similar commodity is a non-bargain sale commodity, that is, when the bargain sale flag Fa is “0”, the price is a standard price.

When the processing of ACT 135 and ACT 136 is completed or it is determined that there is no similar commodity in ACT 134, the processor 111 proceeds to ACT 137. In ACT 137, the processor 111 transmits the permission response command to the information terminal 40 which sent the evaluation request command. The permission response command includes the recommendation level of the evaluation confirmation commodity and the user review. In addition, when a similar commodity is present, the similar commodity information is also included. As described above, the processor 111 ends the information processing once the processor 111 receives the evaluation request command.

The description returns to FIG. 10.

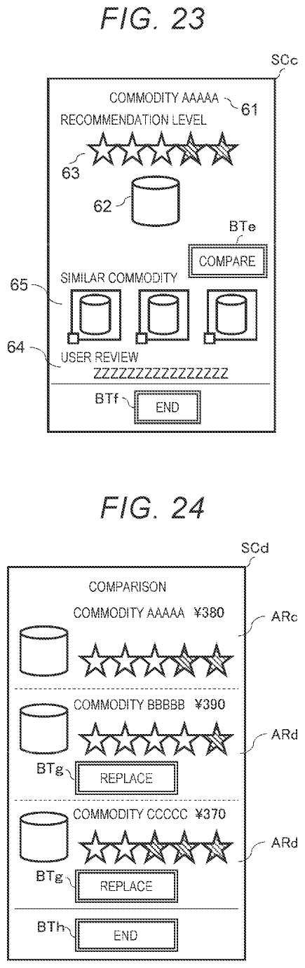

The processor 41 that sent of the evaluation request command then waits for the permission response command in ACT 42. When the permission response command is received via the wireless unit 46, the processor 41 proceeds to ACT 43. In ACT 43, the processor 41 displays an evaluation screen SCc (see FIG. 23) on the touch panel 44 based on data included in the permission response command by the function as the output unit 413. The evaluation screen SCc can be displayed as a pop-up screen superimposed on the registration screen SCb. In some examples, evaluation screen SCc may be displayed instead of the registration screen SCb.

FIG. 23 is a schematic diagram illustrating a display example of the evaluation screen SCc. As shown in the drawing, the evaluation screen SCc displays a commodity name 61, a commodity image 62, a recommendation level 63, and a user review 64 as information related to the evaluation confirmation commodity. The recommendation level 63 is represented here by the number of stars. Specifically, the recommendation level corresponding to the evaluation A is represented by five stars, the recommendation level corresponding to the evaluation B is represented by four stars, the recommendation level corresponding to the evaluation C is represented by three stars, the recommendation level corresponding to the evaluation D is represented by two stars, and the recommendation level corresponding to the evaluation E is represented by one star. Since there are three stars of the recommendation level on the evaluation screen SCc, the purchaser can know that an evaluation of another person for a commodity AAAAA is the evaluation C. Regarding the user reviews 64, the purchaser can browse all the available user reviews 64 by scrolling the evaluation screen SCc upward.

In addition, when a similar commodity is included, an image 65 of the similar commodity is displayed on the evaluation screen SCc. In the evaluation screen SCc, the images 65 of three commodities are displayed as similar commodities of the commodity AAAAA. The purchaser can know from the images 65 that there are three similar commodities among the evaluation confirmation commodities.

The evaluation screen SCc includes a comparison button BTe and an end button BTf. However, when a similar commodity is not included, the comparison button BTe need not be presented. Alternatively, the comparison button BTe can be invalidated by being grayed-out or the like.

The purchaser who has reviewed the evaluation screen SCc touches the end button BTf. The purchaser who wants to compare the evaluation confirmation commodity with a similar commodity (or similar commodities) touches the comparison button BTe. At this time, the purchaser may select a particular similar commodity to be compared with the evaluation confirmation commodity. The selection may be an operation of putting a check mark in a check box attached to the image 65 of the similar commodity, or removing a check mark of a similar commodity which is not to be compared when the check box is checked by default. The selection may be an operation of simply touching the image 65 of the similar commodity.

The description returns to FIG. 10.

The processor 41 that caused the display of the evaluation screen SCc then waits for input of the end button BTf in ACT 44 or input of the comparison button BTe in ACT 45. When the end button BTf is input, the processor 41 proceeds to ACT 46. The processor 41 deletes the evaluation screen SCc in ACT 46 and returns the screen of the touch panel 44 to the registration screen SCb immediately before the evaluation confirmation processing is started. Then, the processor 41 returns to the wait state of ACT 22, ACT 25, and ACT 26 in FIG. 9.

In the wait state of ACT 44 and ACT 45, if the comparison button BTe is input, the processor 41 proceeds to ACT 47. The processor 41 controls the wireless unit 46 to perform a comparison request in ACT 47. By this control, the wireless unit 46 wirelessly transmits a comparison request command. The comparison request command is received by the access point 27 and transmitted to the registration support server 11 via the router 26 of the POS system 20. The comparison request command includes a commodity code of a similar commodity selected as a comparison target. In addition, the comparison request command also includes a member ID. Hereinafter, the similar commodity selected as the comparison target is referred to as a compared similar commodity. In addition, the commodity code of the compared similar commodity is referred to as a comparison commodity code. In the registration support server 11 that receives the comparison request command, comparison request processing is executed.

FIG. 16 is a flowchart illustrating a procedure of the comparison request processing. Upon receiving the comparison request command via the communication interface 115, the processor 111 of the registration support server 11 starts the comparison request processing. In ACT 141, the processor 111 acquires a comparison commodity code from the comparison request command. Then, in ACT 142, the processor 111 determines a recommendation level of the compared similar commodity identified by the comparison commodity code. The recommendation level is determined by a method similar to that of the evaluation confirmation commodity.

When a recommendation level of a comparison confirmation commodity is determined, the processor 111 proceeds to ACT 143. In ACT 143, the processor 143 transmits the permission response command to the information terminal 40 which sent the comparison request command. The permission response command includes the recommendation level of the comparison confirmation commodity. As described above, the processor 111 ends the information processing when the comparison request command is received.

The description returns to FIG. 10.

The processor 41 that sent the comparison request command then waits for the permission response command in ACT 48. When the permission response command is received via the wireless unit 46, the processor 41 proceeds to ACT 49. In ACT 49, the processor 41 displays a comparison screen SCd (see FIG. 24) on the touch panel 44 based on the data included in the permission response command. The comparison screen SCd is displayed as a pop-up screen superimposed on the registration screen SCb or the evaluation screen SCc. In some examples, the comparison screen SCd may be displayed instead of the registration screen SCb or the evaluation screen SCc.

FIG. 24 is a schematic diagram illustrating a display example of the comparison screen SCd. As illustrated in the drawing, the comparison screen SCd is divided into a detail area ARc of the evaluation confirmation commodity and a detail area ARd of the compared similar commodity. In addition, in the comparison screen SCd, an end button BTh is disposed. In the detail area ARc, a commodity name, a price, a recommendation level, and a commodity image of the evaluation confirmation commodity are displayed. When the evaluation confirmation commodity is a bargain sale commodity, the bargain sale commodity mark Ma may be displayed. In the detail area ARd, a commodity name, a price, a recommendation level, and a commodity image of the compared similar commodity are displayed. When the compared similar commodity is a bargain sale commodity, the bargain sale commodity mark Ma may be displayed. Incidentally, FIG. 24 illustrates the comparison screen SCd in which various kinds of information of the evaluation confirmation commodity “commodity AAAAA” and two compared similar commodities “commodity BBBBB” and “commodity CCCCC” are compared.

A replace button BTg is disposed in the detail area ARd of the compared similar commodity. The purchaser who purchases the compared similar commodity instead of the evaluation confirmation commodity touches the replace button BTg disposed in the detail area ARd of the compared similar commodity. A purchaser who does not replace the evaluation confirmation commodity with the compared similar commodity or a purchaser who wants to purchase the compared similar commodity in addition to the evaluation confirmation commodity touches the end button BTh. The detail areas ARc and ARd may further include an explanatory text of a commodity. In addition, when a predetermined position in the detail areas ARc and ARd is touched, a list of user reviews may be displayed.

The description returns to FIG. 10.

The processor 41 that controls the display of the comparison screen SCd waits for the input of the end button BTh in ACT 50 or waits for the input of the replace button BTg by the function as the declaration unit 414 in ACT 51. When the end button BTh is input, the processor 41 proceeds to ACT 52. The processor 41 deletes the comparison screen SCd in ACT 52 and returns the screen of the touch panel 44 to the registration screen SCb immediately before the evaluation confirmation processing is started. Then, the processor 41 returns to the wait state of ACT 22, ACT 25, and ACT 26 in FIG. 9.

In the wait state of ACT 50 and ACT 51, when the replace button BTg is input, the processor 41 proceeds to ACT 53. In ACT 53, the processor 41 sets the commodity code of the compared similar commodity to be purchased instead of the evaluation confirmation commodity in the first code memory 423, and sets the commodity code of the evaluation confirmation commodity in the second code memory 424. Thereafter, in ACT 54, the processor 41 returns the screen of the touch panel 44 to the registration screen SCb as it was before the evaluation confirmation processing started. Then, the processor 41 proceeds to ACT 61 in FIG. 11.

In ACT 61, the processor 41 waits for a registration operation of a commodity to be performed. When the registration operation of the commodity is performed, the processor 41 proceeds to ACT 62. In ACT 62, the processor 41 confirms whether the commodity code input by the registration operation matches with the commodity code stored in the first code memory 423.

When the purchaser who operates the replace button BTg performs a registration operation on a compared similar commodity instead of the evaluation confirmation commodity, the commodity codes match. On the other hand, when the purchaser performs a registration operation on a commodity other than the compared similar commodity, the commodity codes does not match.

When the commodity codes match in ACT 62, the processor 41 proceeds to ACT 63. The processor 41 controls the wireless unit 46 to perform a cancel request by the replace request unit 415 in ACT 63. In addition, the processor 41 controls the wireless unit 46 to perform a registration request in ACT 64. By these controls, the wireless unit 46 first wirelessly transmits a cancel request command. The cancel request command is received by the access point 27 and transmitted to the registration support server 11 via the router 26 of the POS system 20. The cancel request command includes the commodity code stored in the second code memory 424, that is, the commodity code of the evaluation confirmation commodity. In addition, the cancel request command also includes a member ID. Next, the wireless unit 46 wirelessly transmits the registration request command. Similarly to the cancel request command, the registration request command is also received by the access point 27 and transmitted to the registration support server 11 via the router 26 of the POS system 20. The registration request command includes the commodity code stored in the first code memory 423, that is, the commodity code of the compared similar commodity. In the registration support server 11 that receives the cancel request command, cancel request processing is executed.

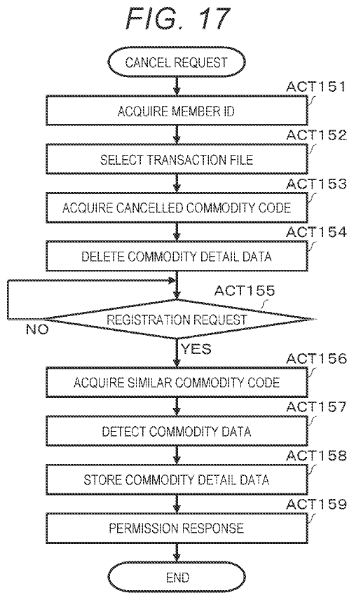

FIG. 17 is a flowchart illustrating a procedure of the cancel request processing. Upon receiving the cancel request command via the communication interface 115, the processor 111 of the registration support server 11 starts the cancel request processing. In ACT 151, the processor 111 acquires the member ID from the cancel request command. Then, in ACT 152, the processor 111 selects the target transaction file 50 in which the member ID is stored.

In ACT 153, the processor 111 acquires the commodity code of the evaluation confirmation commodity from the cancel request command. Hereinafter, the commodity code is referred to as a cancelled commodity code. In ACT 154, the processor 111 deletes commodity detail data including the cancelled commodity code from the target transaction file 50. Then, the processor 111 subtracts “1” from the number of pieces of detail data n to recalculate the total quantity and the total amount.

The processor 111 waits for the registration request command in ACT 155. As described above, after receiving the cancel request command including the commodity code stored in the second code memory 424, the registration support server 11 receives the registration request command including the commodity code stored in the first code memory 423. When the registration request command is received, the processor 111 proceeds to ACT 156. In ACT 156, the processor 111 acquires the commodity code of the compared similar commodity from the registration request command. Then, in ACT 157, the processor 111 searches the commodity data file 15 and detects commodity data including the commodity code. In ACT 158, the processor 111 generates commodity detail data based on the commodity data and stores the commodity detail data in the target transaction file 50. At this time, the processor 111 adds “1” to the number of pieces of detail data n of the target transaction file 50 to recalculate the total quantity and the total amount.

When the processing of ACT 158 is completed, in ACT 159, the processor 111 transmits a permission response command to the information terminal 40 that sent the cancel request command. The permission response command includes the commodity detail data corresponding to the number of pieces of detail data n stored in the target transaction file 50, the total quantity, and the total amount. As described above, the processor 111 ends the information processing when the cancel request command is received.

The description returns to FIG. 11.

The processor 41 that sent the cancel request command and the registration request command then waits for the permission response command in ACT 65. When the permission response command is received via the wireless unit 46, the processor 41 proceeds to ACT 66. In ACT 66, the processor 41 describes in the list memory 421 the commodity detail data corresponding to the number of pieces of detail data n included in the permission response command. In addition, in ACT 67, the processor 41 describes in the total memory 422 the total quantity and the total amount included in the permission response command. Thereafter, when the registration screen SCb is updated in ACT 68, the processor 41 returns to the wait state of ACT 22, ACT 25, and ACT 26 in FIG. 9.

The processing of ACT 66, ACT 67, and ACT 68 can be the same as the processing in ACT 14, ACT 15, and ACT 21 already described above. Therefore, in the updated registration screen SCb, detail data of the evaluation confirmation commodity is deleted, and detail data of the compared similar commodity is newly displayed. At this time, when the compared similar commodity is a bargain sale commodity, the bargain sale commodity mark Ma is displayed. In addition, when the compared similar commodity is an evaluation target commodity, the evaluation mark Mb is displayed. Therefore, when the detail area in which the evaluation mark Mb is displayed is touched, the evaluation screen SCc in which the compared similar commodity is set as the evaluation confirmation commodity is displayed on the touch panel 44.

In the wait state of ACT 22, ACT 25, and ACT 26 or the wait state of ACT 25 and ACT 26 in FIG. 9, when the payment button BTd is input, the processor 41 proceeds to ACT 27. The processor 41 controls the wireless unit 46 to perform a settlement request in ACT 27. By this control, the wireless unit 46 wirelessly transmits a settlement request command. The settlement request command is received by the access point 27 and transmitted to the registration support server 11 via the router 26 of the POS system 20. The settlement request command includes a member ID. In the registration support server 11 that receives the settlement request command, settlement request processing is executed.

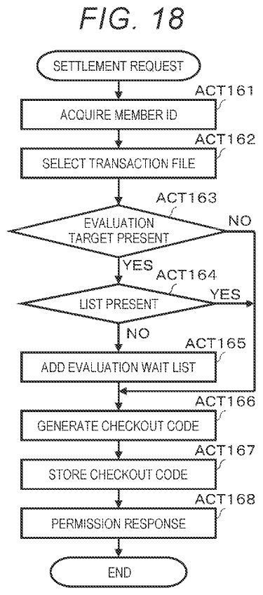

FIG. 18 is a flowchart illustrating a procedure of the settlement request processing. When the processor 111 of the registration support server 11 receives the settlement request command via the communication interface 115, the processor 111 starts the settlement request processing. In ACT 161, the processor 111 acquires the member ID from the settlement request command. Then, in ACT 162, the processor 111 selects the target transaction file 50 in which the member ID is stored.

In ACT 163, the processor 111 confirms whether the commodity detail data of the evaluation target commodity is present in the commodity detail data stored in the target transaction file 50. The commodity detail data in which the evaluation flag Fb is “1” is the commodity detail data of the evaluation target commodity. When the commodity detail data of the evaluation target commodity is present, the processor 111 proceeds to ACT 164. In ACT 164, the processor 111 confirms whether the evaluation waiting data of the evaluation target commodity is present in the evaluation waiting list of the member data including the member ID acquired in ACT 161. When the evaluation waiting data is absent, the processor 111 adds the evaluation waiting data including the commodity code and the commodity name of the evaluation target commodity to the evaluation waiting list matching the member data in ACT 165. When the evaluation waiting data is present, the processor 111 skips the processing of ACT 164.

When the processing of ACT 164 is completed or skipped, the processor 111 proceeds to ACT 166. In addition, when the commodity detail data of the evaluation target commodity is absent in ACT 163, the processor 111 proceeds to ACT 166. In ACT 166, the processor 111 generates a unique checkout code. Then, in ACT 167, the processor 111 stores the checkout code in the target transaction file 50. Thereafter, in ACT 168, the processor 111 transmits a permission response command to the information terminal 40 which sent the settlement request command. The permission response command includes the checkout code.

The description returns to FIG. 9.

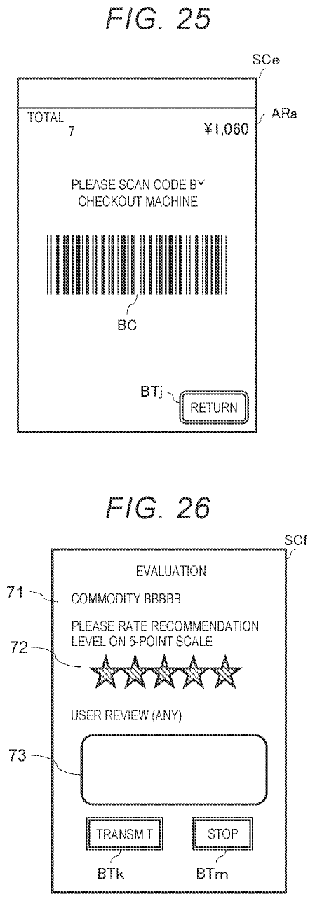

In ACT 30, the processor 41 that sent the settlement request command waits for the permission response command. When the permission response command is received via the wireless unit 46, the processor 41 proceeds to ACT 29. In ACT 29, the processor 41 sets the screen of the touch panel 44 as a checkout screen SCe (see FIG. 25).

FIG. 25 is a schematic diagram illustrating a display example of the checkout screen SCe. As illustrated in the drawing, a checkout code included in the permission response command is displayed as a barcode BC on the checkout screen SCe. In addition, a return button BTj is disposed.

A customer who confirms a checkout screen SCj scans the barcode BC of the checkout screen SCj with a scanner of the dedicated checkout machine 24. Accordingly, a settlement command is transmitted from the dedicated checkout machine 24 to the registration support server 11. The settlement command includes data of the barcode BC, that is, a checkout code.

The processor 111 acquires the checkout code from the settlement command. Then, the processor 111 transmits the data of the transaction file 50, matching checkout code to the dedicated checkout machine 24 which sent the settlement command. Accordingly, the customer pays the price after confirming the content of the transaction displayed on a display of the dedicated checkout machine 24. When the payment of the price is completed, a settlement completion command is transmitted from the dedicated checkout machine 24 to the registration support server.

The processor 111 waits for the settlement completion command. After the settlement completion command is received, the processor 111 then transmits the settlement completion command to the information terminal 40 matching the member ID of the transaction file 50.

The description returns to FIG. 9.

In ACT 30, the processor 41 of the information terminal 40 which displays the checkout screen SCe waits for the settlement completion command. When the settlement completion command is received via the wireless unit 46, the processor 41 proceeds to ACT 31. The processor 41 controls the wireless unit 46 to perform an evaluation waiting request in ACT 41. By this control, the wireless unit 46 wirelessly transmits an evaluation waiting request command. The evaluation waiting request command is received by the access point 27 and transmitted to the registration support server 11 via the router 26 of the POS system 20. The evaluation waiting request command includes a member ID. In the registration support server 11 that receives the evaluation waiting request command, evaluation waiting request processing is executed.

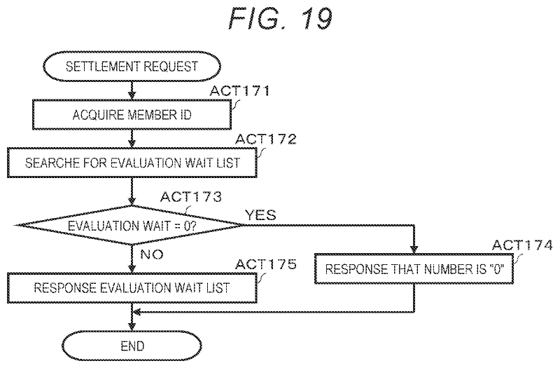

FIG. 19 is a flowchart illustrating a procedure of the evaluation waiting request processing. Upon receiving the evaluation waiting request command via the communication interface 115, the processor 111 of the registration support server 11 starts the evaluation waiting request processing. In ACT 171, the processor 111 acquires the member ID from the evaluation waiting request command. Then, in ACT 172, the processor 111 searches for the evaluation waiting list of the member data including the member ID. In ACT 173, the processor 111 confirms whether evaluation waiting data, that is, data including a commodity code and a commodity name of an evaluation waiting commodity is stored in the evaluation waiting list. When no evaluation waiting data is stored, the processor 111 proceeds to ACT 174. In ACT 174, the processor 111 transmits a response command indicating that the number of evaluation waiting commodities is equal to 0 to the information terminal 40. On the other hand, when the evaluation waiting data is stored in the evaluation waiting list, the processor 111 proceeds to ACT 175. In ACT 175, the processor 111 transmits the response command including the evaluation waiting data to the information terminal 40.

The description returns to FIG. 9.

The processor 41 that sent the evaluation waiting request command now waits for the response command in ACT 32. In the wait state, when the response command indicating that the number of evaluation waiting commodities is equal to 0 is received, the processor 41 determines NO in ACT 32 and returns to ACT 2 of FIG. 8. On the other hand, when the response command including the evaluation waiting data is received, the processor 41 determines YES in ACT 32 and proceeds to ACT 33. In ACT 33, the processor 41 updates the data of the evaluation waiting list 432 to the evaluation waiting data included in the response command. Thereafter, the processor 41 returns to ACT 2 in FIG. 8. Thereafter, the processor 41 executes the processing after ACT 2 in the same manner as described above.

Therefore, when the response command including the evaluation waiting data is received, the screen of the touch panel 44 is the second top screen SCa. Therefore, the purchaser who wants to evaluate an evaluation waiting commodity touches the evaluation button BTa.

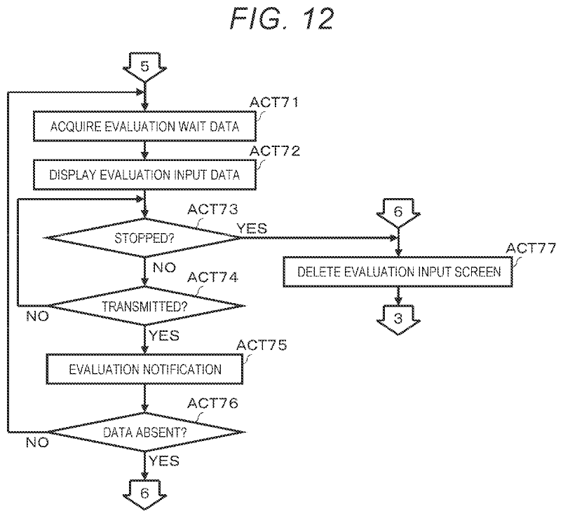

When the evaluation button BTa is input, the processor 41 of the information terminal 40 determines YES in ACT 6 of FIG. 8, and proceeds to ACT 71 of FIG. 12. In ACT 71, the processor 41 acquires the evaluation waiting data from the evaluation waiting list. Then, in ACT 72, the processor 41 sets the screen of the touch panel 44 as an evaluation input screen SCf (refer to FIG. 26) based on the evaluation waiting data by the function as the evaluation reception unit 416.

FIG. 26 is a schematic diagram illustrating a display example of the evaluation input screen SCf. As illustrated in the drawing, the evaluation input screen SCf displays a commodity name 71 of the evaluation target commodity identified by the commodity code of the evaluation waiting data, an evaluation input unit 72, and a user review input unit 73. In addition, on the evaluation input screen SCf, a transmission button BTk and a stop button BTm are disposed. The evaluation input unit 72 is a unit in which a purchaser inputs an evaluation (recommendation level) of the evaluation target commodity according to the number of stars.

The purchaser who confirms the evaluation input screen SCf inputs the number of stars suitable for the own evaluation for the evaluation target commodity. For example, when the evaluation is the highest evaluation, five stars are input. When the evaluation is a next level evaluation, four stars are input. Thereafter, the number of stars is reduced every time the evaluation is lowered, and one star is input when the evaluation is the lowest evaluation. In addition, when there is an item to be posted as a user review, the purchaser inputs a comment to the user review input unit 73. Accordingly, when the evaluation of the evaluation target commodity is completed, the purchaser touches the transmission button BTk. When the evaluation is to be stopped, the purchaser touches the stop button BTm.

The description returns to FIG. 12.

The processor 41 that controls the display of the evaluation input screen SCf waits for input of the stop button BTm or input of the transmission button BTk in ACT 73. When it is detected that the transmission button BTk is input in the wait state of ACT 73 and ACT 74, the processor 41 proceeds to ACT 75. In ACT 75, the processor 41 controls the wireless unit 46 to perform an evaluation notification by the function as the evaluation transmission unit 417. By this control, the wireless unit 46 wirelessly transmits an evaluation notification command. The evaluation notification command is received by the access point 27 and transmitted to the registration support server 11 via the router 26 of the POS system 20. The evaluation notification command includes a commodity code and evaluation information of the evaluation target commodity evaluated by the purchaser, the number of stars, and data of the user review. In addition, the evaluation notification command also includes a member ID. In the registration support server 11 that receives the evaluation notification command, evaluation notification processing is executed.

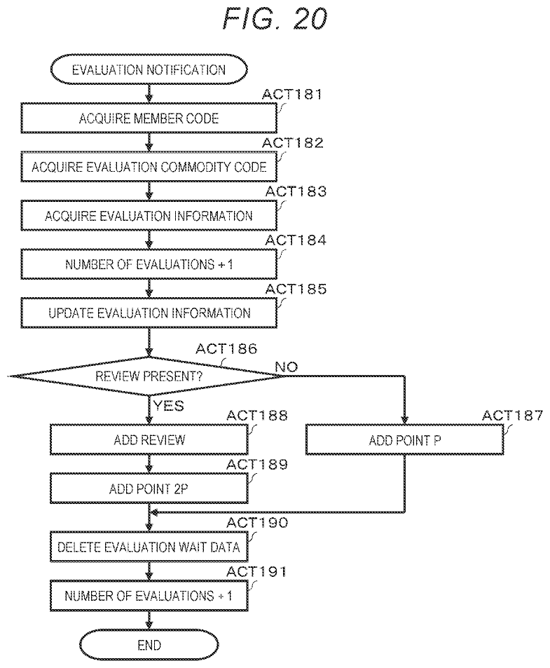

FIG. 20 is a flowchart illustrating a procedure of the evaluation notification processing. Upon receiving the evaluation notification command via the communication interface 115, the processor 111 of the registration support server 11 starts the evaluation notification processing. In ACT 181, the processor 111 acquires the member ID from the evaluation notification command. In ACT 182, the processor 111 acquires the commodity code of the evaluation target commodity from the evaluation notification command. Further, in ACT 183, the processor 111 acquires the evaluation information from the evaluation notification command.

The processor 111 searches the evaluation data file 16 in ACT 184, and adds “1” to the number of evaluations of evaluation data including the commodity code acquired in the processing of ACT 182. In addition, the processor 111 updates the evaluation information of the same evaluation data in ACT 185. That is, when the evaluation information acquired in the processing of ACT 183 is, for example, the evaluation A, the processor 111 adds one point to the score Va. For example, for the evaluation B, the processor 111 adds one point to the score Vb. The same applies to the evaluation C, evaluation D, and evaluation E.

In ACT 186, the processor 111 confirms whether a user review is included in the evaluation notification command. When the user review is not included, the processor 111 proceeds to ACT 187. In ACT 187, the processor 111 searches the member data file 14, and adds a specified point P to the service point of the member data including the member ID acquired in the processing of ACT 181. On the other hand, when the user review is included, the processor 111 proceeds to ACT 188. In ACT 188, the processor 111 searches the evaluation data file 16, and adds the user review to the evaluation data including the commodity code acquired in the processing of ACT 182. In addition, in ACT 189, the processor 111 searches the member data file 14, and adds a point 2P that is twice the specified point P to the service points of the member data including the member ID acquired in the processing of ACT 181.

When the processing of ACT 187 or ACT 189 is completed, the processor 111 proceeds to ACT 190. In ACT 190, the processor 111 searches the member data file 14, and deletes, from the member data including the member ID acquired in the processing of ACT 181, the evaluation waiting data of the commodity code acquired in the processing of ACT 182. In addition, in ACT 191, the processor 111 adds “1” to the number of times of evaluation of the same member data. Then, the processor 111 ends the evaluation notification processing.

The description returns to FIG. 12.

In ACT 76, the processor 41 which sent the evaluation notification command checks whether all the evaluation waiting data in the evaluation waiting list 432 has been processed. When unprocessed evaluation waiting data remains in the evaluation waiting list 432, the processor 41 returns to ACT 71. The processor 41 acquires the still unprocessed evaluation waiting data and executes the processing after ACT 72 in the same manner as described above.

On the other hand, when the processing is completed for all the evaluation waiting data in the evaluation waiting list 432, the processor 41 proceeds to ACT 77. In addition, in the wait state of ACT 73 and ACT 74, when the stop button BTm is input, the processor 41 proceeds to ACT 77. The processor 41 deletes the evaluation input screen SCf in ACT 77. Thereafter, the processor 41 returns to ACT 2 in FIG. 8. Description of Effect of Self Commodity Registration System

As is clear from the above description of the operation, according to the self commodity registration system 100, when a purchaser who is a user of the information terminal 40 purchases a commodity on a sales floor, the purchaser can easily confirm an evaluation performed on the commodity by another purchaser. Therefore, since a superiority of the self commodity registration system 100 is improved, the number of members who are the users of the information terminal 40 can be increased.

In addition, the purchaser can compare an evaluation performed by another purchaser on a commodity to be purchased with an evaluation performed by another purchaser on a commodity similar to the commodity. As a result of the comparison, when the similar commodity is purchased instead of the to-be-purchased commodity, it is only necessary to touch the replace button BTg of the comparison screen SCd and perform the registration operation of the commodity code of the similar commodity. That is, it is not necessary to perform a special operation for canceling the registration of the to-be-purchased commodity. Therefore, the purchaser can purchase the similar commodity instead of the to-be-purchased commodity by a simple operation.

When an evaluation target commodity is included in commodities purchased by a purchaser who is a user of the information terminal 40, the evaluation button BTa is displayed on the top screen SCa of the information terminal 40. When the purchaser touches the evaluation button BTa, the screen of the touch panel 44 transitions to the evaluation input screen SCf of the evaluation target commodity. The purchaser can evaluate the evaluation target commodity or post a user review from the evaluation input screen SCf. Therefore, the evaluation of the evaluation target commodity can be collected from the purchaser without the purchaser feeling a burden. In addition, since a service point is given to the purchaser who performs the evaluation, it is expected that plural purchasers perform the evaluation. In addition, since the number of service points given by posting user reviews is doubled, it is expected that a large number of user reviews can be collected.

### Other Embodiments

In the above-described embodiment, a case in which a purchaser who purchased an evaluation target commodity evaluates the commodity is described as an example. In another embodiment, a case in which a seller who sells a to-be-purchased commodity evaluates the to-be-purchased commodity will be described as an example.

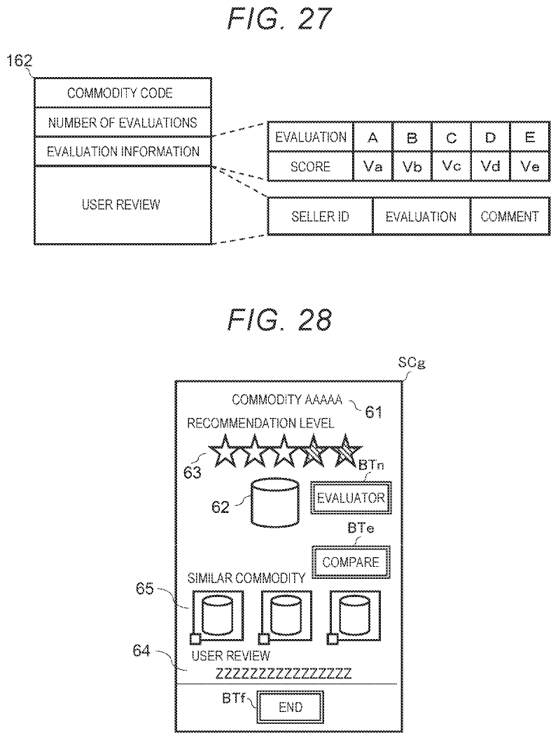

FIG. 27 is a schematic diagram illustrating a configuration of evaluation data 162 stored in the evaluation data file 16 in another embodiment. In the evaluation data 161 of a previously described embodiment, the member ID of a purchaser who posted a comment and the evaluation of the purchaser are included along with a comment of a user review. In the evaluation data 162 of another embodiment, a seller ID for individually identifying a seller who posted a comment and an evaluation of the seller are included along with a comment of a user review. Accordingly, a seller who evaluates an evaluation target commodity and the information of the evaluation by the seller can be specified by seller ID. It is necessary in such case for a seller to post a user review for evaluating the evaluation target commodity.

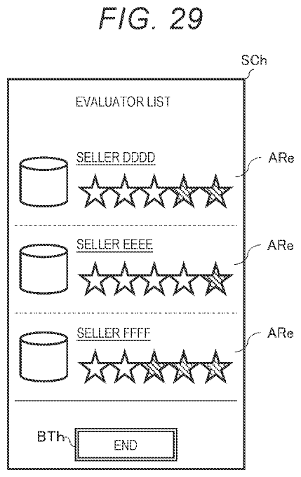

FIG. 28 is a schematic diagram illustrating an example of an evaluation screen SCg displayed on the touch panel 44 of the information terminal 40 in an embodiment. The evaluation screen SCg is different from the evaluation screen SCc of the previously described embodiment in that an evaluator button BTn is added. When the purchaser who checks the evaluation screen SCc wants to know the information of the seller who evaluated the evaluation target commodity, the purchaser touches the evaluator button BTn. Accordingly, the screen of the touch panel 44 transitions to an evaluator list screen SCh (see FIG. 29).

FIG. 29 is a schematic diagram illustrating a display example of the evaluator list screen SCh. As illustrated, the evaluator list screen SCh displays a detail area ARe for each seller. In addition, the end button BTh is disposed on the evaluator list screen SCh. In each detail area ARe, a name of the seller who evaluated the evaluation target commodity and the number of stars indicating the evaluation from the seller are displayed. The purchaser who has finished checking the evaluator list screen SCh touches the end button BTh. When the end button BTh is touched, the screen of the touch panel 44 returns to the evaluation screen SCg. The detail areas ARe in some examples may further display a text review from the corresponding seller.

According to this other embodiment, when the purchaser purchases a commodity on a sales floor, the purchaser can easily check, by using the information terminal 40, an evaluation performed on the commodity by a seller. In general, it may be expected that the evaluation of the commodity by the seller will be highly reliable to the purchaser. Therefore, since such evaluation data can be fairly useful for selecting a commodity to be purchased, it can be expected that the number of users of the information terminals 40 will be further increased. That is, the advantages of the self commodity registration system can be further improved.

As still the another embodiment, when a particular detail area ARe is selected on the evaluator list screen SCh, evaluation information about other commodities reviewed by the corresponding seller can be displayed on the touch panel 44. Accordingly, the purchaser can easily identify another commodity that is highly evaluated by a reliable seller, and thus it is expected that sales will be promoted.

In the present embodiment, the registration support server 11 includes a first evaluation data file 16 in which the evaluation data 161 by the purchaser is stored and a second evaluation data file 16 in which the evaluation data 162 by the seller is stored. The evaluation screen displayed on the touch panel 44 of the information terminal 40 may display the evaluation by the purchaser and the evaluation by the seller in a distinguishable manner. By adopting such a configuration, the purchaser can see an evaluation by another purchaser and the evaluation by the seller together, and thus the advantages of the self commodity registration system can be further improved.

### Modifications

In an embodiment, the registration support server 11 may determine the recommendation level of a similar commodity in the evaluation request processing described with reference to FIG. 15 and include the determined recommendation level in the permission response command. Accordingly, in the information terminal 40, the processing of ACT 47 and ACT 48 described with reference to FIG. 10 can be omitted. That is, when the comparison button BTe of the evaluation screen SCc is pressed, the processor 41 can display the comparison screen SCd without performing a comparison request. Therefore, the registration support server 11 does not need the comparison request processing described with reference to FIG. 16.

In an embodiment, when the user of the information terminal 40 is a purchaser of the evaluation target commodity, the case where the evaluation target commodity is evaluated using the information terminal 40 is described as an example. However, the purchaser who can evaluate the evaluation target commodity is not limited just to the users of an information terminal 40. An evaluation can also be received from a purchaser other than the user of an information terminal 40. For example, a questionnaire sheet can be distributed to the purchasers who purchased the evaluation target commodity by some other means. Such evaluations may be collected on a paper medium or through the Internet or the like. In addition, when a mail address of the purchaser is known, a questionnaire response may be obtained by using the mail.

Embodiments can be applied not only to a self commodity registration system in which a smartphone owned by a purchaser is used as the information terminal 40, but also to a self commodity registration system in which a cart terminal provided by a store is used.

In an embodiment, the functions of the registration support server 11 may be provided in another server, for example, the store server 21. The registration support server 11 can be a cloud server or the like, providing the necessary functions. With such a server there may be an advantage in that evaluations of purchasers who purchase the evaluation target commodity from any of a plurality of stores can be collectively managed. On the other hand, when the store server 21 provides the necessary functions, there may be an advantage in that an evaluation of a purchaser who purchased the evaluation target commodity is specialized (specific) to the one store and can be managed as such in potentially greater detail.

In the evaluation screen SCc or the comparison screen SCd, the method of showing an evaluation is not limited to use of stars or the number of stars. For example, the scores for the evaluations A to E may be indicated by a graph such as a bar graph or a pie graph, or the scores may be directly displayed as numerical values or the like to indicate evaluations. In addition, when the evaluation target commodity or the compared similar commodity is selected on the evaluation screen SCc or the comparison screen SCd, a sentence (short summary) or the like describing details of the commodity may be displayed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information terminal to be operated by a purchaser on a store sales floor to register commodities for purchase in conjunction with a server device supporting registration of commodities to be purchased, the information terminal comprising:
a commodity code reader configured to read commodity codes on commodities to be purchased;
a display screen configured to display information to a purchaser and receive input operations from the purchaser;
a communication interface configured to communicate with a server device; and
a processor configured to:
acquire a commodity code for an item to be purchased from the commodity code reader or an input operation via the display screen;
send a registration request including the acquired commodity code to the server device via the communication interface to request the server device to perform sales registration on the corresponding item; and
display evaluation information associated with the commodity code in the server device on the display screen when the server device sends the evaluation information in response to the registration request, the evaluation information including an evaluation of the item by another person.

2. The information terminal according to claim 1, wherein the evaluation information further includes information related to a similar commodity that has been set as similar to the item associated with the commodity code included in the registration request sent to the server device.

3. The information terminal according to claim 2, wherein the processor is further configured to cause the display screen to display the information related to the similar commodity along with the evaluation of the item on a comparison screen.

4. The information terminal according to claim 3, wherein
the comparison screen includes a replacement button to receive a declaration to purchase the similar commodity instead of the item, and
the processor is further configured to:
send a request to the server device to register the similar commodity for purchase instead of the item after the replacement button is pressed and a commodity code associated with the similar commodity is acquired from the commodity code reader or an input operation via the display screen.

5. The information terminal according to claim 1, wherein the evaluation of the item by another person is from another purchaser who previously purchased the item.

6. The information terminal according to claim 1, wherein the processor is further configured to:
request an input of evaluation information from the purchaser regarding the item when the server device indicates the item is an evaluation target commodity in response to the registration request; and
transmit the evaluation information from the purchaser regarding the item to the server device after the input of the evaluation information from the purchaser regarding the item.

7. The information terminal according to claim 1, wherein the evaluation of the item by another person is from a seller of the item.

8. The information terminal according to claim 7, wherein the evaluation information is displayed with information specifying the seller who performed the evaluation of the item.

9. A non-transitory, computer-readable storage medium storing program instructions, which when executed by an information terminal to be operated by a purchaser on a store sales floor to register commodities for purchase, causes the information terminal to perform a method comprising:
acquire a commodity code for an item to be purchased from a commodity code reader or an input operation via a display screen;
send a registration request including the acquired commodity code to a server device via a communication interface to request the server device to perform sales registration on the corresponding item; and
display evaluation information associated with the commodity code in the server device on the display screen when the server device sends the evaluation information in response to the registration request, the evaluation information including an evaluation of the item by another person.

10. The non-transitory, computer-readable storage medium according to claim 9, wherein the evaluation information further includes information related to a similar commodity that has been set as similar to the item associated with the commodity code included in the registration request that was sent to the server device.

11. The non-transitory, computer-readable storage medium according to claim 9, the method further comprising:
cause the display screen to display the information related to the similar commodity along with the evaluation of the item on a comparison screen.

12. The non-transitory, computer-readable storage medium according to claim 11, wherein
the comparison screen includes a replacement button to receive a declaration to purchase the similar commodity instead of the item, and
the method further comprises:
send a request to the server device to register the similar commodity for purchase instead of the item after the replacement button is pressed and a commodity code associated with the similar commodity is acquired from the commodity code reader or an input operation via the display screen.

13. The non-transitory, computer-readable storage medium according to claim 9, wherein the evaluation of the item by another person is from another purchaser who previously purchased the item.

14. The non-transitory, computer-readable storage medium according to claim 9, the method further comprising:
request an input of evaluation information from the purchaser regarding the item when the server device indicates the item is an evaluation target commodity in response to the registration request; and
transmit the evaluation information from the purchaser regarding the item to the server device after the input of the evaluation information from the purchaser regarding the item.

15. The non-transitory, computer-readable storage medium according to claim 9, wherein the evaluation of the item by another person is from a seller of the item.

16. The non-transitory, computer-readable storage medium according to claim 15, wherein the evaluation information is displayed with information specifying the seller who performed the evaluation of the item.

17. A method for self-registration systems, the method comprising:
inputting identification information for a commodity to be purchased by a purchaser on a store sales floor;
sending a request to a server to perform sales registration of the commodity identified by the input identification information; and
displaying, on a display screen, evaluation information returned from the server in response to the request to the server to perform sales registration of the commodity when the evaluation information is associated with identification information for the commodity on the server, the evaluation information including an evaluation of the commodity from another person.

18. The method according to claim 17, wherein the evaluation information further includes information related to a similar commodity that has been set as similar to the commodity included in the request sent to the server.

19. The method according to claim 18, further comprising:
causing the display screen to display the information related to the similar commodity along with the evaluation of the commodity on a comparison screen.

20. The method according to claim 19, wherein
the comparison screen includes a replacement button to receive a declaration to purchase the similar commodity instead of the commodity, and
the method further comprises:
sending a request to the server to register the similar commodity for purchase instead of the commodity when the replacement button has been pressed.
